(19) United States
(12) Patent Application Publication
(10) Pub. No.: US 2012/0053632 A1
(43) Pub. Date: Mar. 1, 2012

(54) PACIFIER

(76) Inventor: Tamir TIROSH, Menahemia (IL)

(21) Appl. No.: 12/868,759

(22) Filed: Aug. 26, 2010

(51) Int. Cl. A61J 17/00

(52) U.S. Cl. 606/236

(57) ABSTRACT

A pacifier for a baby of the type having a rigid shield, further comprising: a nipple; and a plug for securing the nipple to the rigid shield. The pacifier comprises a shock absorbing feature disposed on an outer facing portion of the pacifier, for absorbing a shock in the event that the baby falls forward. In exemplary embodiments, the shock absorbing feature comprises a resilient member disposed between a plug base and plug head; a resilient loop-shaped member; or a pillow-like member.

### FIELD OF THE INVENTION

The present invention relates to baby products, in particular, pacifiers.

### BACKGROUND OF THE INVENTION

The present generation of pacifiers is typically comprises a soft nipple held to a fairly rigid plastic shield by a rigid plastic plug. These shields and plugs are not designed to provide protection from a baby falling and potentially injuring the mouth area. This issue is particularly of concern as prior to the age of about 9-12 months of age, babies do not have the parachute reflex (the tendency to put out their hands upon falling), and so they are prone to injuring their mouths, etc upon falling at an early age.

Older style pacifier designs include pacifiers with a soft disk-like shield (e.g. made of rubber or silicone). These shields are particularly large in order to prevent swallowing as they are soft and can bend/deform easily thereby allowing ingestion if not for their large size.

As mentioned, more modern pacifiers comprise rigid shields which thus need not be oversized, and have other advantages such as lower cost, the possibility of printing on the shield, a smoother touch on the baby's face and reduced skin irritation; but on the other hand do not provide significant protection to the baby's mouth if the baby falls forward.

### SUMMARY OF THE INVENTION

The present invention relates to pacifiers of the type having a rigid shield. In addition to the rigid shield, such pacifiers comprise a nipple on one side of the shield and a plug on the other side of the shield, which secures the nipple. Some kind of handle is also commonly present.

It is an object of the present invention to provide such a pacifier with a shock absorbing feature. This shock absorber feature or mechanism is achieved by incorporating a plug with an associated shock absorber (e.g. resilient material such as an annular component, a loop, etc; a pillow; cushion; foam; gel). The shock absorber may be integrally formed, associated with or attached to the pacifier—typically the plug, but alternatively associated with the shield. In whichever embodiment, the shock absorber mechanism comprises a pillow, cushion, foam material, gel, or other resilient/energy absorbing material or design, or combination thereof, or other such appropriate shock absorber mechanism.

According to embodiments of one aspect of the present invention, there is provided a pacifier for a baby of the type having a rigid shield, further comprising: a nipple; and a plug for securing the nipple to the rigid shield, wherein the pacifier comprises a shock absorbing feature disposed on an outer facing portion of the pacifier, for absorbing a shock in the event that the baby falls forward.

In some embodiments, the shock absorbing feature comprises a resilient member of the plug; and in some of those embodiments the resilient member is accordion-shaped, and or the resilient member is annular and disposed between a plug base and plug head of the plug, and/or the plug base comprises an alignment mechanism, and for example the alignment mechanism comprises at least one guide aperture with at least one cooperating and correspondingly disposed extension fitting into the guide aperture(s). In other of those embodiments, the shock absorbing feature comprises a resilient loop-shaped member attached to the plug or the shield. In yet other of those embodiments, the shock absorbing feature comprises a pillow-like member; and in some of such embodiments, the pillow-like member comprises a gas therein, and/or a foamed member therein, and/or a gel therein; and in particular embodiments the pillow-like member comprises a plurality of cells therein.

According to embodiments of another aspect of the present invention, there is provided a pacifier plug for a pacifier for securing a nipple to a rigid shield, the plug comprising: a shock absorbing feature disposed on an outer facing portion of the plug, for absorbing a shock in the event that the baby falls forward.

### BRIEF DESCRIPTION OF THE DRAWINGS

The present invention will be understood and appreciated more fully from the following detailed description taken in conjunction with the appended drawings in which:

FIG. 1 is a perspective exploded view of an embodiment of a pacifier of the present invention;

FIGS. 2A and 2B are cross-sectional views from the side of FIG. 1 in the non-compressed and compressed positions, respectively;

FIG. 3 is a cross-sectional view of the embodiment of FIG. 1, however illustrating the pacifier including an exemplary handle;

FIGS. 4-7 are two perspective views and two cross-sectional views, respectively, of another embodiment of the pacifier of the present invention;

FIGS. 8-11 are a perspective view, a cross-sectional view, an exploded perspective view and another cross-sectional view, of additional embodiments of the pacifier of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

Illustrative embodiments of the invention are described below. In the interest of clarity, not all features/components of an actual implementation are necessarily described.

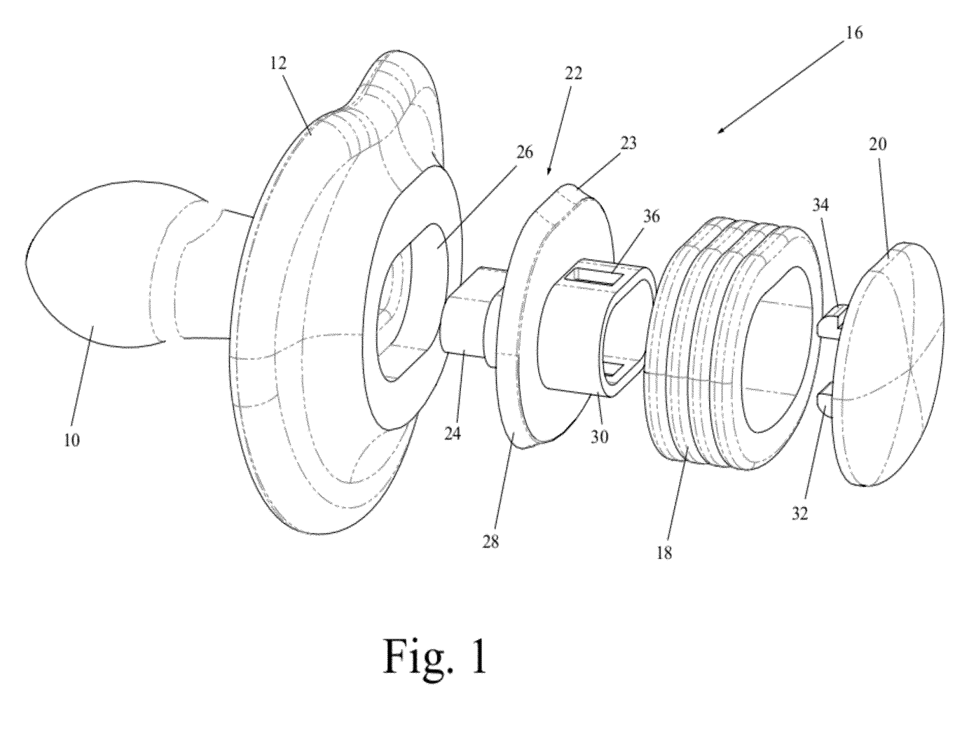

FIGS. 1-3 show a first embodiment of a shock absorbing pacifier comprising a nipple 10, a rigid shield 12, a handle 14, and a plug 16 for securing the aforementioned parts together.

Plug 16 comprises a shock absorber such as an annular resilient member 18 and a plug head 20 and a plug base 22. Plug base 22 has a nipple fixing member 24 for securing nipple 10 to rigid shield 12 at a nipple and plug base receiving opening 26 in the shield. Plug base 22 also comprises a disk-shaped member 28 from which projects a plug head guide 30 for interacting and guiding the plug head in the event of compression of the shock absorbing annular resilient member 18 as may occur in the case of a baby falling forward on the pacifier when the pacifier is in the baby's mouth. To help seat resilient member between plug head 20 and plug base 22, either or both of plug head 20 and plug base 22 may comprise a beveled edge 23 (visible on the plug base in FIG. 1), a groove (not shown) or the like corresponding to the edge(s) of annular resilient member 18 to help positioning of the resilient member.

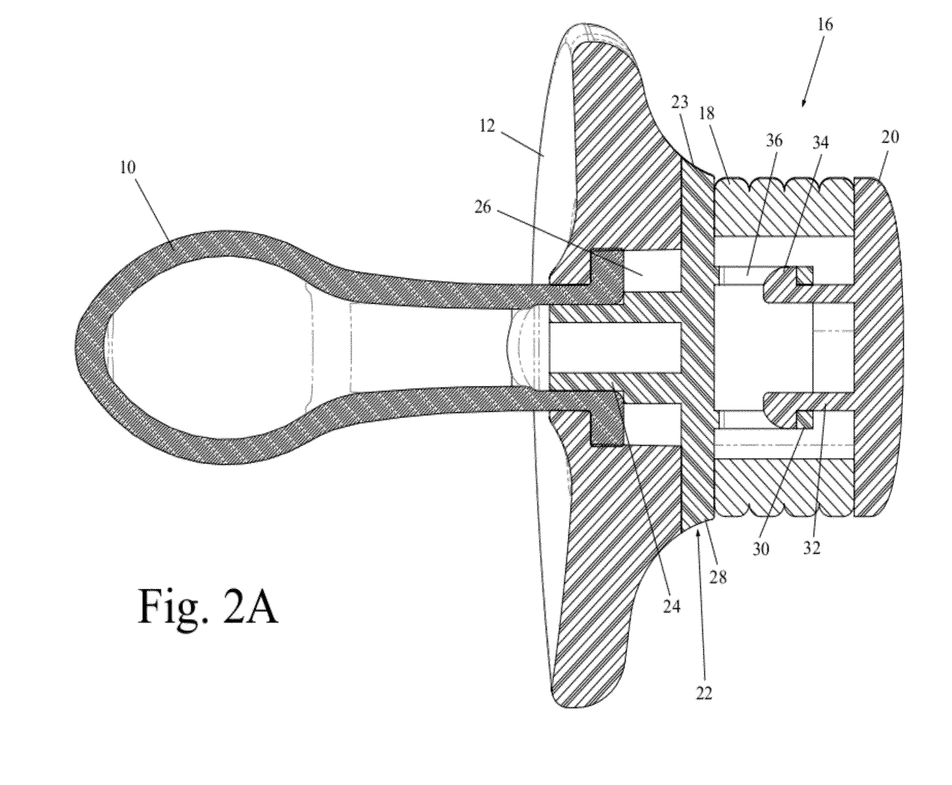

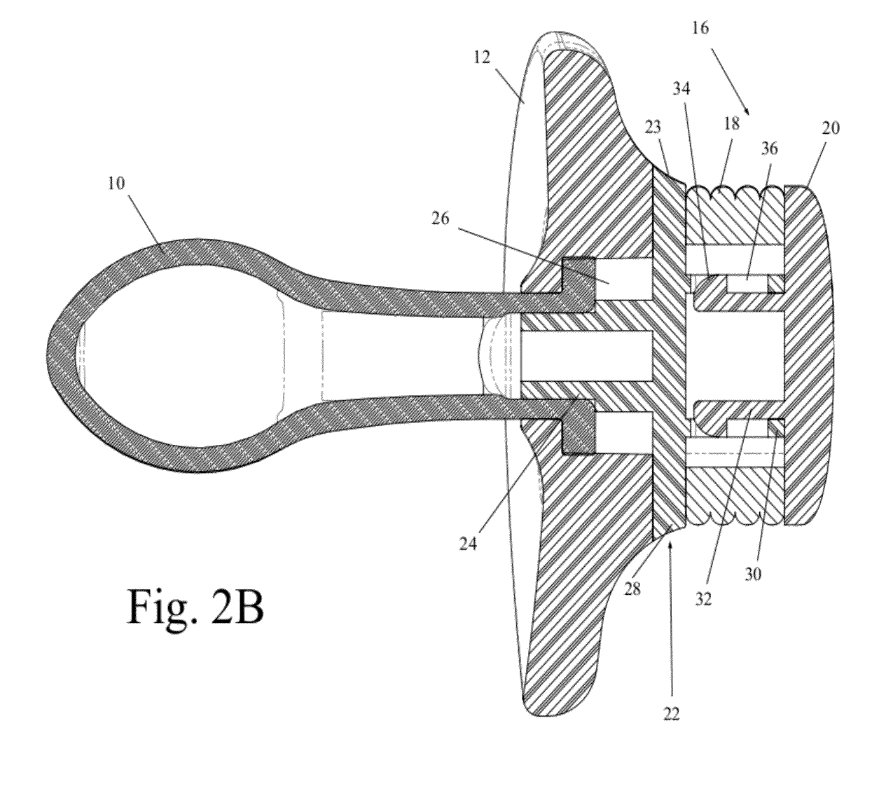

Plug head 20 has a pair of extensions 32 with snap fit ends 34 for fitting into guide apertures 36 of plug head guide 30. Guide apertures 36, which act as an alignment mechanism, are elongated, for example rectangular to allow extensions 32 to slide forward and back as resilient member 18 is respectively compressed and recovers its shape. FIG. 2A illustrates plug 16 (i.e. resilient member 18) in a non-compressed state and FIG. 2B illustrates plug 16 (i.e. resilient member 18) in a compressed (shock absorbing) state. In some embodiments, resilient member 18 has an accordion-like shape, for example as illustrated, to help absorb shock.

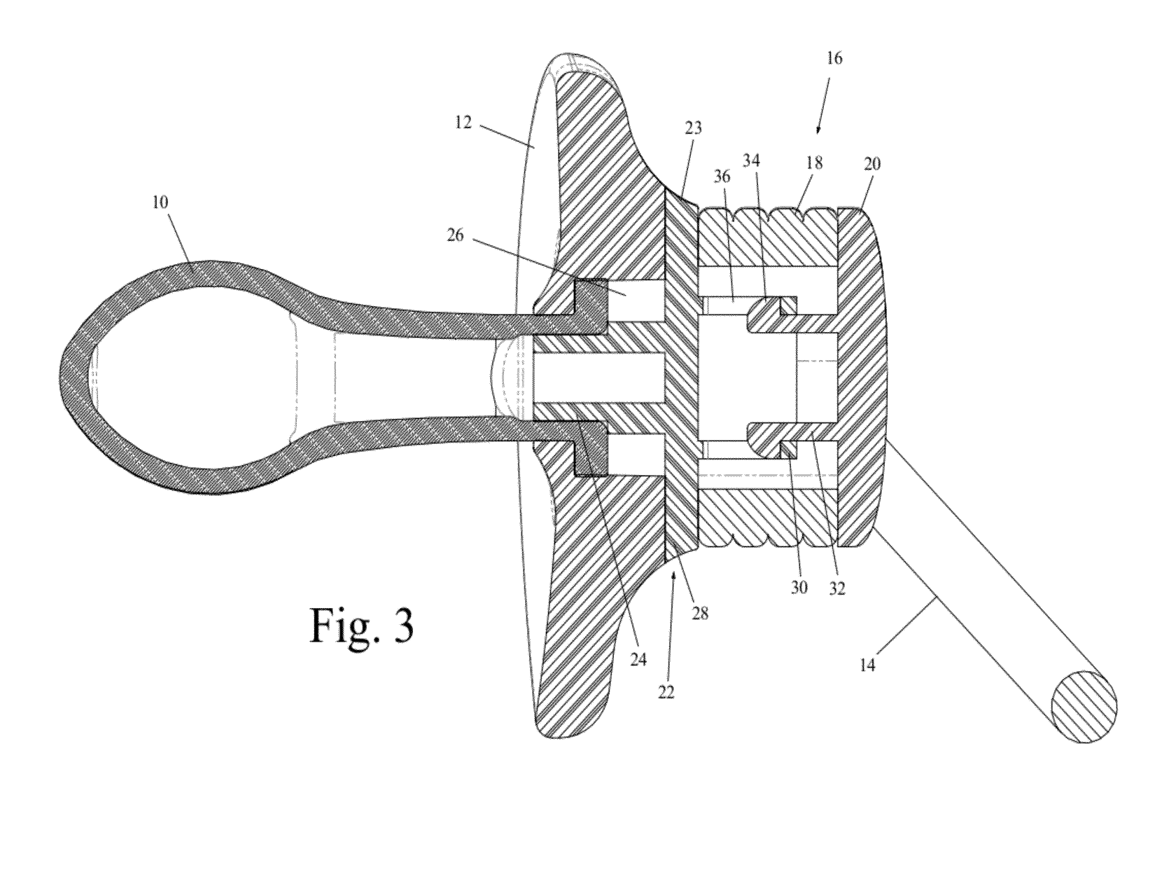

FIG. 3 illustrates a pacifier as in the above embodiment however wherein there is further illustrated the pacifier including exemplary handle 14. Handle 14 is shown attached to resilient member 18 however it should be understood that the handle could be attached to any appropriate portion of the pacifier.

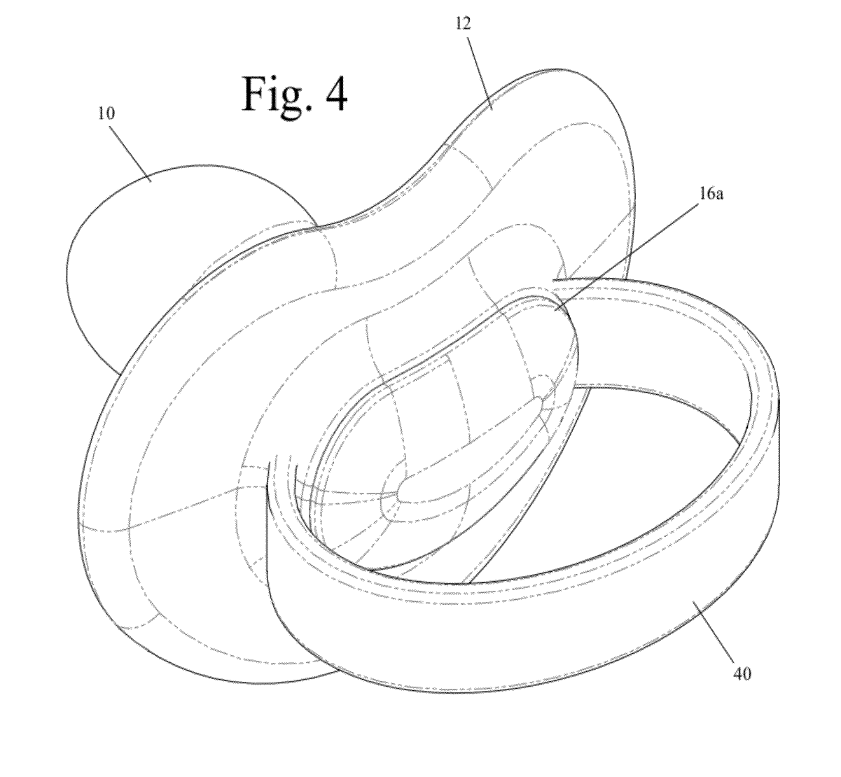

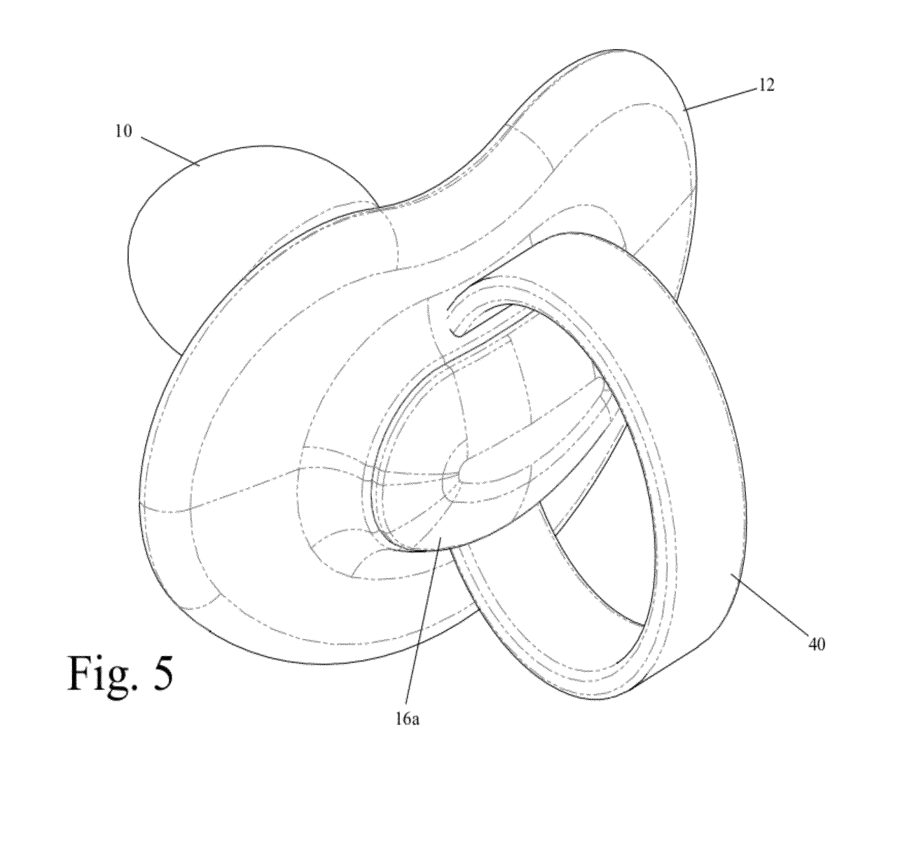

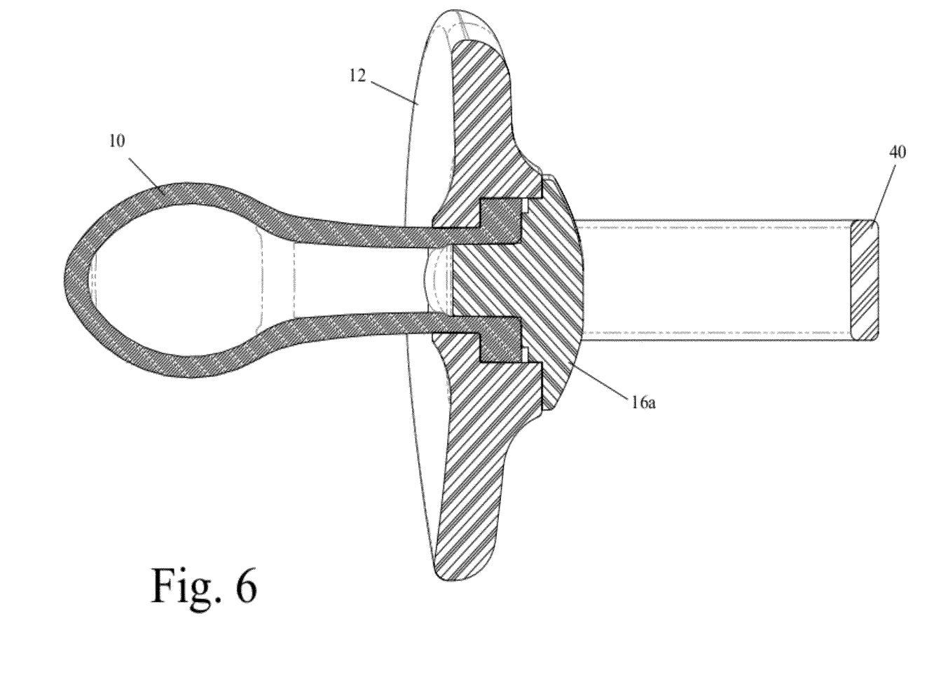

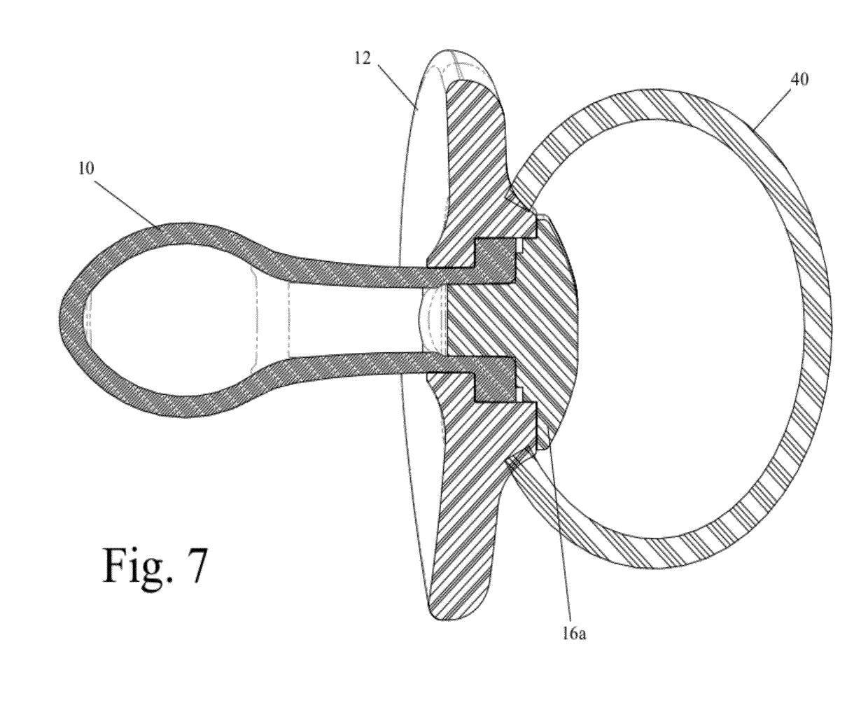

FIGS. 4-7 show a second embodiment of a shock absorbing pacifier comprising a shock absorbing mechanism in the form of a resilient loop 40 associated with (integrally formed with or attached to) the plug, designated plug 16a as it is typically not of the design of plug 16, rather is typically of a standard one-piece plug design, with the exception of the loop (see FIGS. 6-7). Loop 40 is made of a resilient material such as rubber and is typically in a generally circular or oval shape whereby the loop can absorb shock at a variety of impact angles. Loop 40 also has the advantage of being useful as a handle. As seen, loop 40 can be connected in a variety of positions with respect to rigid shield 12, for example with the loop generally parallel to the baby's lips (FIGS. 4 and 6) or perpendicular thereto (FIGS. 5 and 7). Alternatively, the shock absorber mechanism comprises a component with a shock/energy absorbing design, such as a spring,

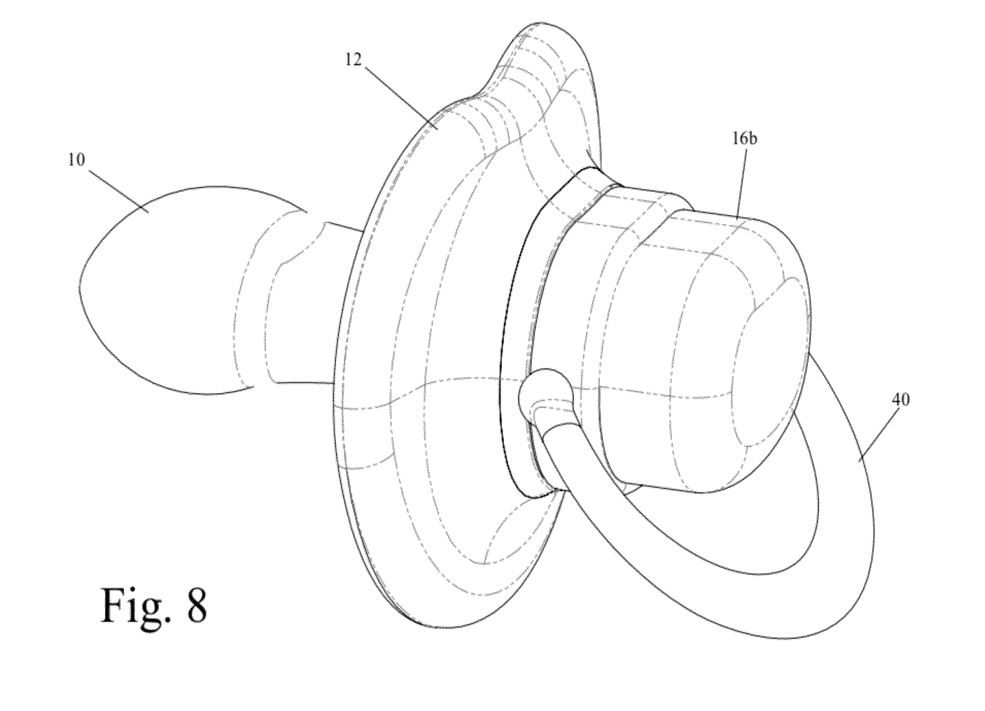

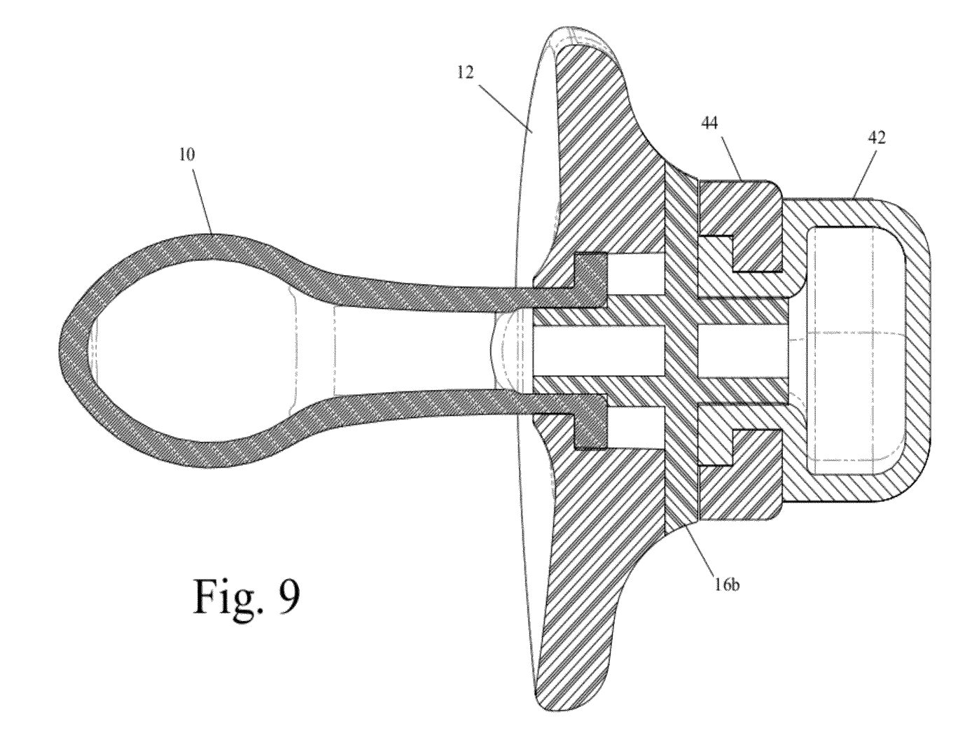

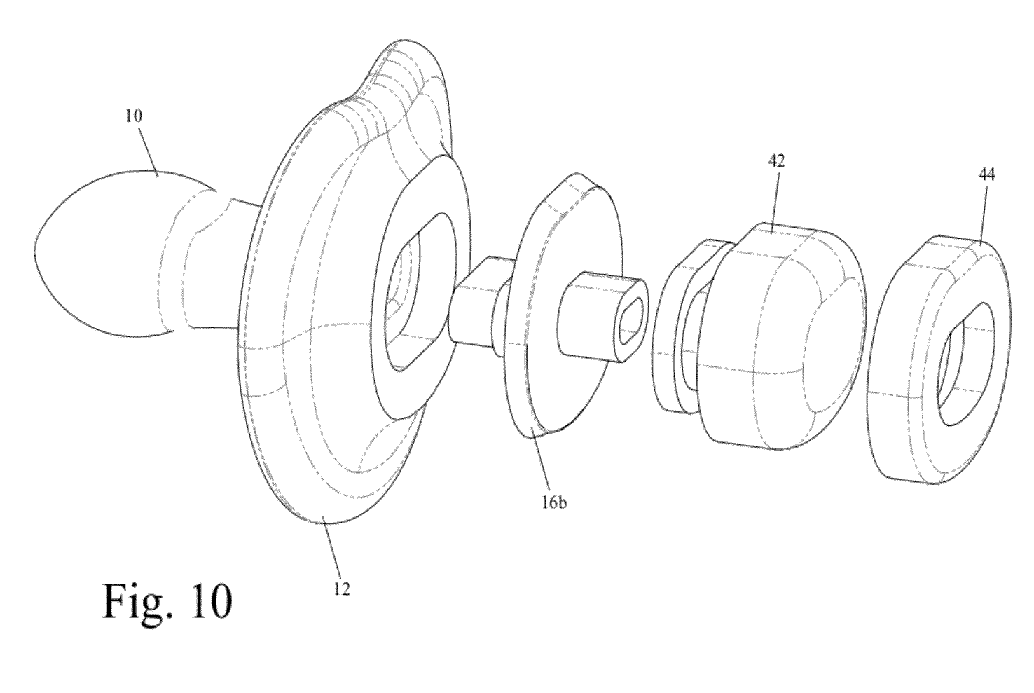

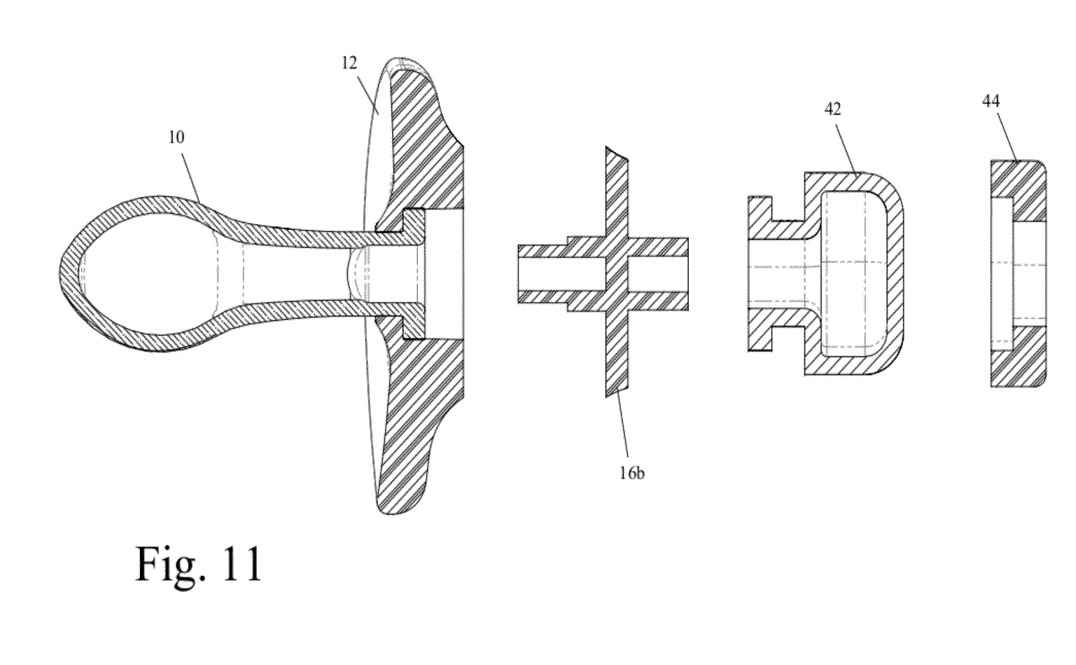

FIGS. 8-11 illustrate a third embodiment, with modifications thereof, of a shock absorbing pacifier comprising a shock absorbing mechanism, in this case in the form of a cushion or pillow 42 filled with a compressible shock absorbing material or shock deflecting material such as air or other gas or a foam or liquid (e.g. gel). The main concept of this material/design is that associated with a plug 16b there is a mechanism and/or material that provides a shock absorbing or deflecting capability. In some embodiments pillow 42 includes a plurality of shock absorbing pockets or cells (not visible). Whether designed as a one-celled shock absorbing component, like pillow 42, or as a plurality of cells, in some embodiments, at least one side wall of the pillow or cell(s) comprises a more pliable (i.e. elastic) characteristic than other walls. This increased elasticity may be due to the use of a different material or simply due to the use of a thinner wall.

In some embodiments, pillow 42 is attached to plug 16b by an attachment ring 44, as illustrated, however, in other embodiments the pillow is integrally formed, attached directly or attached by other means.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A pacifier for a baby of the type having a rigid shield, further comprising:
a nipple; and
a plug for securing the nipple to the rigid shield, wherein the pacifier comprises a shock absorbing feature disposed on an outer facing portion of the pacifier, for absorbing a shock in the event that the baby falls forward.

2. The pacifier of claim 1, wherein the shock absorbing feature comprises a resilient member of the plug.

3. The pacifier of claim 2, wherein the resilient member is accordion-shaped.

4. The pacifier of claim 2, wherein the resilient member is annular and disposed between a plug base and plug head of the plug.

5. The pacifier of claim 4, wherein the plug base comprises an alignment mechanism.

6. The pacifier of claim 5, wherein the alignment mechanism comprises at least one guide aperture with at least one cooperating and correspondingly disposed extension fitting into the guide aperture(s).

7. The pacifier of claim 1, wherein the shock absorbing feature comprises a resilient loop-shaped member attached to the plug or the shield.

8. The pacifier of claim 1, wherein the shock absorbing feature comprises a pillow-like member.

9. The pacifier of claim 8, wherein the pillow-like member comprises a gas therein.

10. The pacifier of claim 8, wherein the pillow-like member comprises a foamed member therein.

11. The pacifier of claim 8, wherein the pillow-like member comprises a gel therein.

12. The pacifier of claim 8, wherein the pillow-like member comprises a plurality of cells therein.

13. A pacifier plug for a baby pacifier for securing a nipple to a rigid shield, the plug comprising: a shock absorbing feature disposed on an outer facing portion of the plug, for absorbing a shock in the event that the baby falls forward.

14. The plug of claim 13, wherein the shock absorbing feature comprises a resilient member of the plug.

15. The pacifier of claim 14, wherein the resilient member is accordion-shaped.

16. The pacifier of claim 14, wherein the resilient member is annular and disposed between a plug base and plug head of the plug.

17. The pacifier of claim 16, wherein the plug base comprises an alignment mechanism.

18. The pacifier of claim 17, wherein the alignment mechanism comprises at least one guide aperture with at least one cooperating and correspondingly disposed extension fitting into the guide aperture(s).

19. The pacifier of claim 13, wherein the shock absorbing feature comprises a resilient loop-shaped member attached to the plug or the shield.

20. The pacifier of claim 13, wherein the shock absorbing feature comprises a pillow-like member.
